(19) United States
(12) Patent Application Publication
(10) Pub. No.: US 2005/0269385 A1
(43) Pub. Date: Dec. 8, 2005

(54) Soldering method and solder joints formed therein

(75) Inventors: Sinn-Wen Chen, Hsinchu (TW); Shih-Kang Lin, Hsinchu (TW); Ching-Feng Yang, Hsinchu (TW); Yu-Chih Huang, Hsinchu (TW); Ting-Ying Chung, Hsinchu (TW); Ying-Mei Tsai, Hsinchu (TW); An-Ren Zi, Hsinchu (TW)

Correspondence Address: BACON & THOMAS, PLLC, 625 SLATERS LANE, FOURTH FLOOR, ALEXANDRIA, VA, 22314, US

(73) Assignee: National Tsing Hua University, Hsinchu (TW)

(21) Appl. No.: 10/859,207

(22) Filed: Jun. 3, 2004

(51) Int. Cl. B23K 31/02; C22C 13/02

(52) U.S. Cl. 228/180.22; 428/615

(57) ABSTRACT

This invention forms an indium or indium alloy layer on top of a Sn based lead-free solder. The indium or indium alloy layer can be formed by various methods, such as plating, deposition, printing, dipping, etc. The indium-containing layer melts during the soldering process, wets the substrate, and forms a sound solder joint. Since the melting point of indium is 156.6° C., even lower than that of the eutectic Sn—Pb which is at 183° C., so the soldering process can be carried out at a temperature lower than the conventional soldering process. During the soldering process, the indium reacts with the Sn based Pb-free solder alloy. Since the eutectic temperature of Sn—In is at 120° C., during the short time of the soldering process, the surface of the In deposited Pb-free solder remains as the liquid phase and have a good wetting with the substrate, while a In gradient is formed in the In deposited Pb-free solder.

### FIELD OF THE INVENTION

The present invention relates to a lead-free solder, and particularly to a lead-free solder formed with an indium or indium alloy layer on the surface thereof.

### BACKGROUND OF THE INVENTION

Soldering is the most common joining technology used in the electronic industry. The reliability of electronic products is also directly related to the quality of the solder joints. However, due to the concerns of environmental protection and industrial safety, recently there are a lot of efforts in the electronic industry to look for proper lead-free solders to replace the conventional Sn—Pb alloys. At present, the eutectic or near-eutectic Sn—Ag—Cu alloys are the most promising candidates for the lead-free solders. Even though the Sn—Ag—Cu alloy has good properties, its melting point is about 30° C. higher than that of the conventional eutectic Sn—Pb alloy. The introduction of a solder with such a high melting point will undoubtly cause changes in the manufacturing processes and energy cost increases in the electronic industry. A eutectic Sn—In solder is a good lead-free solder with a relatively low melting point. However, indium is an expensive material. The indium content in the eutectic Sn—In alloy is as high as 49 wt%. Thus, the cost of the Sn—In solder becomes too high, which contributes to the major disadvantage of its use.

Other than having a higher melting point, the Sn—Ag—Cu alloy is a ternary alloy. Flip chip technique recently has attracted more and more attention in the electronic industry. Along with the development of this technology, the preparation of solder bumps on the flip chip substrate has been gradually shifted from the conventional thick film printing technique to an electroplating process in order to meet the demand of an increasingly higher density package. It is apparent that a ternary alloy is not easy to be electroplated, and thus will hinder the development of the flip chip technique. Moreover, a recent study on Sn—Cu—Ag alloy indicates that, different from the conventional Sn—Pb alloy, the intermetallics formed during the soldering process of the Sn—Ag—Cu solder are very sensitive to the content of Cu. In other word, the control of the Cu content needs to be very accurate in making the Sn—Ag—Cu solder. The ternary alloy per se is difficult to be formed by electroplating, and to achieve an accurate control of its composition will be more difficult.

One objective of the present invention is to solve the problems associated with the current Sn—Ag—Cu solder, which include a high melting point and difficulty in electroplating, and a high cost if the eutectic Sn—In solder is used.

The present invention adopts the use of an indium or indium alloy layer formed on the surface of a lead-free solder. Such an indium or indium alloy layer can be formed by various methods, such as electroplating, deposition, printing, dipping, etc. This indium-containing metal layer melts in a soldering process, wets two metal substrates above and below said metal layer, and the resulting molten metal layer solidifies to form a sound solder joint when the temperature thereof is lowered. Since the melting point of indium is only 156.6° C., lower than that of the eutectic Sn—Pb of 183° C., the soldering operation can be carried out at a lower temperature. During the soldering process, indium will react with the tin-containing lead-free solder beneath the indium or indium alloy layer. Since the eutectic temperature of Sn—In is 120° C., during the short soldering period, the solder will form a gradient of indium content, while its surface will remain a liquid phase and has a good wetting with the substrate. Thus an increase in the temperature of the liquid phase due to an excessive amount of tin dissolution during the soldering process will not occur during the short soldering period. No such soldering technique with the indium-contained layer can be found in the literatures.

In known applications, a method is disclosed to reduce the soldering temperature by adding a eutectic solder into a solder with a high lead content [Nah et al., Journal of Applied Physics, Vo. 94(12), pp. 7560-7566, 2003]. Professor Zheng, Z. B. in the University of Seoul has disclosed the addition of eutectic Sn—Bi into a eutectic Sn-3.5 wt % Ag solder [2004 TMS annual meeting, Charlotte, N.C., USA]. The objectives of the above-mentioned two prior arts are to lower the soldering temperature. However, the solder disclosed by Nah et al. (2003) contains lead and does not comply with the current trend of developing a lead-free solder. The solder disclosed by Professor Zheng (2004) contains Bi and will have a problem of brittle solder joint associated with a Bi-containing solder. Furthermore, since Bi is very similar to Pb, the toxicity of a Bi-containing solder to human is still under investigation. Fuerhaupter [Fuerhaupter et al., U.S. Pat. No. 5,320,272, 1994] has disclosed a method of plating a thin layer (e.g. Au) on Sn—Bi in order to improve the problem of brittleness associated with a Bi-containing solder, which is different from the present invention of plating indium for lowering the soldering temperature.

There are many literatures related to indium [Krueger et al., DE 3306154, 1984; Weigert et al., EP 0787818, 1997]. However, none of them is identical to the technique disclosed in the present invention. Digiacomo Giulio of IBM [U.S. Pat. No. 6,025,649, 2000] has also disclosed a Sn—Pb solder column, where one end of the column is plated with indium. Such a structure, after reflow, can form a Pb—Sn—In solder joint to increase the fatigue resistance of the solder joint. The feature of the invention disclosed in U.S. Pat. No. 6,025,649 is to improve the fatigue resistance of the solder joint by using indium, which is completely different from the features of the present invention: lowering the soldering temperature and using a lead-free solder. The present invention uses plated indium, and indium has a lot of advantages including low melting point, good fatigue resistance, and mild interfacial reactions, etc. More importantly, from pure In to a eutectic composition, an In—Sn system has a broad range of composition, and a gentle gradient of the melting point and composition changes. This will enable the present invention having a wider applicable composition range for forming a concentration gradient at the solder joint.

In addition to the abovementioned advantages, Professor Ipser of the University of Vienna, Austria has pointed out the problem that a solder with a high tin content might form a brittle tin pest at a low temperature [2004 TMS annual meeting, Charlotte, N.C., USA]. Ipser has disclosed that the problem of tin pest can be significantly improved by introducing indium into tin. This will be an advantage of the present invention which adopts an indium layer on the lead-free solder. The reasons why a lead-free solder joint having a gradient of In content of the present invention are applicable are a low melting point of indium, and a broad and mild eutectic region of the eutectic Sn—In alloy. Tamura and Murayam [JP2001219267, 2001] have developed a method for preparing a Sn—In—Bi-based solders by two plating steps (Sn—In plating and Sn—Bi plating) in 2001. However, the objective of their study is to prepare a ternary alloy, which is not related to the features of the present invention of using the low melting point of indium, and a broad and mild eutectic region of the eutectic Sn—In alloy. The use of a lead-free solder is imperative and has become a mainstream in the development of the flip chip technique. The trend of a reduced clearance has made the use of a plating technique being a must. Thus, the present invention has an immediate advantage of commercial applications.

### SUMMARY OF THE INVENTION

This invention forms an indium or indium alloy layer on top of a Sn based lead-free solder. The indium or indium alloy layer can be formed by various methods, such as plating, deposition, printing, and dipping, etc. The indium-containing layer melts during the soldering process, wets the substrate in contact therewith and the lead-free solder, and forms a sound solder joint after cooling. Since the melting point of indium is 156.6° C., even lower than the melting point, 183° C., of the eutectic Sn—Pb alloy, so the soldering process can be carried out at a temperature lower than the conventional soldering process. During the soldering process, the indium reacts with the Sn based Pb-free solder alloy to form a liquid phase region. Since the eutectic temperature of Sn—In is at 120° C., the surface of the In- or In alloy-deposited Pb-free solder remains as the liquid phase and have a good wetting with the substrate during the short time of the soldering process, while an In gradient is formed in the In- or In alloy-deposited Pb-free solder.

According to the present invention, indium or indium alloy is plated on the external surface of the Pb-free solder. Indium has many advantages including low melting point, good fatigue resistance, and mild interfacial reactions, etc. More importantly, from pure In to a eutectic composition, an In—Sn system has a broad range of compositions, and a gentle gradient of the melting point and composition changes. This will enable the present invention having a wider applicable composition range for forming a concentration gradient at the solder joint.

### BRIEF DESCRIPTION OF THE FIGURES

FIG. 1 is an optical microscopic metallic phase photo showing the cross-section of an In-plated tin substrate formed in Example 1 of the present invention;

FIG. 2 is an optical microscopic metallic phase photo showing the cross-section of a solder joint of an In-plated tin substrate and a nickel substrate formed in Example 2 of the present invention; and

FIG. 3 is an optical microscopic metallic phase photo showing the cross-section of a solder joint of an In-plated tin substrate and a copper substrate formed in Example 3 of the present invention.

### DETAILED DESCRIPTION OF THE INVENTION

Preferred embodiments of the present invention includes (but not limited thereto) the following:
1. A solder joint connecting two substrates, which comprises:
   a lead-free solder layer attached to a surface of a first substrate, said lead-free solder contains tin and is substantially free of lead;
   an indium-containing layer attached to a surface of a second substrate, said indium-containing layer is indium or an indium alloy having a melting point lower than a melting point of said lead-free solder; and
   a gradient layer connecting said lead-free solder layer to said indium-containing layer, said gradient layer having a substantially increasing gradient of indium content from said lead-free solder layer towards said indium-containing layer, and said gradient layer comprising a liquid phase reaction product of said lead-free solder layer and said indium-containing layer.
2. The solder joint as recited in Item 1, wherein said lead-free solder is tin.
3. The solder joint as recited in Item 1, wherein said lead-free solder is a tin alloy.
4. The solder joint as recited in Item 3, wherein said tin alloy is a Sn—Ag, Sn—Cu, or Sn—Ag—Cu alloy.
5. The solder joint as recited in Item 1, wherein said indium-containing layer is indium.
6. The solder joint as recited in Item 2, wherein said indium-containing layer is indium, and said liquid phase reaction product comprises a eutectic Sn—In alloy.
7. The solder joint as recited in Item 3, wherein said indium-containing layer is indium, and said liquid phase reaction product comprises a eutectic Sn—In alloy.
8. The solder joint as recited in Item 4, wherein said indium-containing layer is indium, and said liquid phase reaction product comprises a eutectic Sn—In alloy.
9. The solder joint as recited in Item 1, wherein said solder joint contains less than 49 wt % of indium, based on the total weight of said solder joint.
10. The solder joint as recited in Item 9, wherein said solder joint contains less than 30 wt % of indium, based on the total weight of said solder joint.
11. A method for soldering two substrates, which comprises the following steps:
   a) preparing a first substrate having an indium-containing lead-free solder bump comprising a lead-free solder layer attached to a surface of said first substrate, and an indium-containing layer formed on said lead-free solder layer, wherein said lead-free solder comprises tin and is substantially free of lead, and said indium-containing layer is indium or an indium alloy having a melting point lower than a melting point of said lead-free solder;
   b) contacting said surface of said first substrate with a surface of a second substrate, and heating said indium-containing lead-free solder bump to melt said indium-containing layer and initiate a liquid phase reaction of said indium-containing layer and said lead-free solder layer; and
   c) cooling said indium-containing lead-free solder bump between the two surfaces of said first substrate and said second substrate to bind said first substrate and said second substrate.
12. The method as recited in Item 11, wherein said indium-containing lead-free solder bump is formed by electroplating, depositing or printing a lead-free solder layer on the surface of said first substrate, and electroplating, depositing or printing an indium-containing layer on said lead-free solder layer.
13. The method as recited in Item 12, wherein said indium-containing layer is electroplated on said lead-free solder layer.
14. The method as recited in Item 11, wherein said lead-free solder is tin.
15. The method as recited in Item 11, wherein said lead-free solder is a tin alloy.
16. The method as recited in Item 15, wherein said tin alloy is Sn—Ag, Sn—Cu, or Sn—Ag—Cu.
17. The method as recited in Item 11, wherein said indium-containing layer is indium, and said liquid phase reaction forms a eutectic Sn—In alloy.
18. The method as recited in Item 12, wherein said indium-containing layer is indium, and said liquid phase reaction forms a eutectic Sn—In alloy.
19. The method as recited in Item 13, wherein said indium-containing layer is indium, and said liquid phase reaction forms a eutectic Sn—In alloy.
20. The method as recited in Item 14, wherein said indium-containing layer is indium, and said liquid phase reaction forms a eutectic Sn—In alloy.
21. The method as recited in Item 15, wherein said indium-containing layer is indium, and said liquid phase reaction forms a eutectic Sn—In alloy.
22. The method as recited in Item 16, wherein said indium-containing layer is indium, and said liquid phase reaction forms a eutectic Sn—In alloy.
23. The method as recited in Item 11, wherein said indium-containing lead-free solder bump contains less than 49 wt % of indium, based on the total weight of said indium-containing lead-free solder bump.
24. The method as recited in Item 23, wherein said indium-containing lead-free solder bump contains less than 30 wt % of indium, based on the total weight of said indium-containing lead-free solder bump.

The present invention is more particularly described in the following examples that are intended as illustrative only since numerous modifications and variations therein will be apparent to those skilled in the art.

### EXAMPLE 1

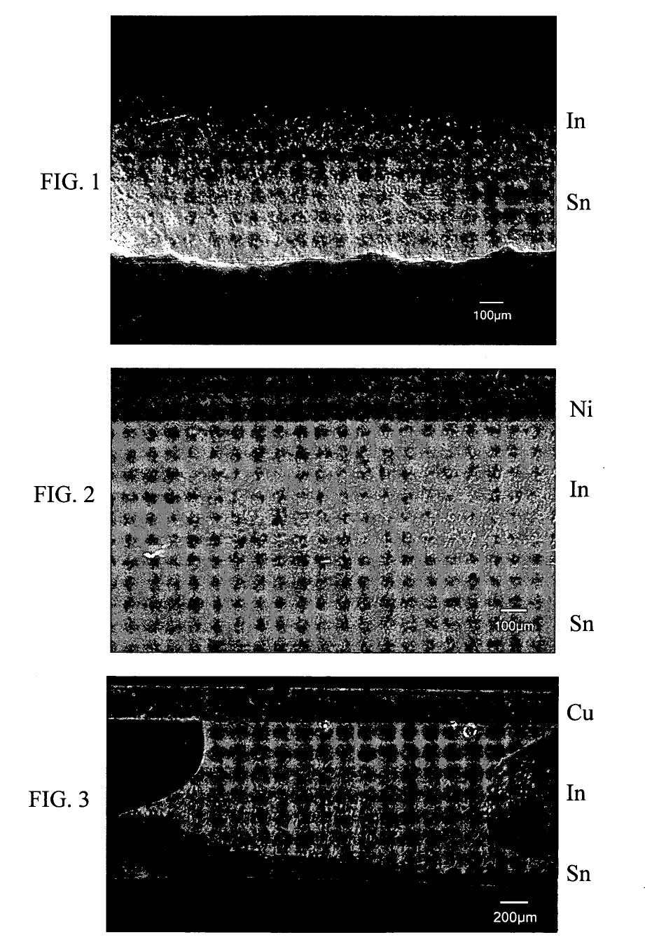

An acidic electroplating solution of indium sulfate (0.1M) was used to perform plating of indium on the surface of a tin substrate by using Pt as anode, a current density of 3.3 A/dM², and an operation temperature of 40° C. After one hour, a uniform indium layer with a thickness of about 100 μm was obtained, as shown in FIG. 1.

### EXAMPLE 2

An In-plated tin substrate similar to Example 1 was used to perform a reflow soldering with a nickel substrate at 170° C. The thickness of the indium layer was 500 μm, and the reflow time was 2 minutes. A sound solder joint was formed. A liquid phase reaction portion was seen at the interface between indium and tin. During the soldering process, a liquid phase of indium was formed, and a portion of the tin was also dissolved. A multi-phase region was observed after solidification. Said multi-phase region was a region including said liquid phases of indium and tin, and an interface-reaction region prior to solidification by cooling. As shown in the metallic phase photo of FIG. 2, the multi-phase region is about 80 μm in thickness.

### EXAMPLE 3

An In-plated tin substrate similar to Example 1 was used to perform a reflow soldering with a copper substrate at 170° C. The thickness of the indium layer was 500 pin, and the reflow time was 5 minutes. A sound solder joint was formed. A liquid phase reaction portion was seen at the interface between indium and tin. During the soldering process, a liquid phase of indium was formed, and a portion of the tin was also dissolved. A multi-phase region was observed after solidification. Said multi-phase region was a region including said liquid phases of indium and tin, and an interface-reaction region prior to solidification by cooling. As shown in the metallic phase photo of FIG. 3, the multi-phase region is about 80 μm in thickness.

### EXAMPLE 4

An In-plated Sn—Ag substrate was used to perform a reflow soldering with a nickle substrate at 170° C. The thickness of the indium layer was 500 μm, and the reflow time was 2 minutes. A sound solder joint was formed.

### EXAMPLE 5

An In-plated Sn—Ag substrate was used to perform a reflow soldering with a copper substrate at 170° C. The thickness of the indium layer was 500 μm, and the reflow time was 2 minutes. A sound solder joint was formed.

### EXAMPLE 6

An In-plated Sn—Ag—Cu substrate was used to perform a reflow soldering with a nickel substrate at 170° C. The thickness of the indium layer was 500 m, and the reflow time was 2 minutes. A sound solder joint was formed.

### EXAMPLE 7

An In-plated Sn—Ag—Cu substrate was used to perform a reflow soldering with a copper substrate at 170° C. The thickness of the indium layer was 500 μm, and the reflow time was 2 minutes. A sound solder joint was formed.

Although the present invention has been described with reference to specific details of certain embodiments thereof, it is not intended that such details should be regarded as limitations upon the scope of the invention except as and to the extent that they are included in the accompanying claims. Many modifications and variations are possible in light of the above disclosure.

1. A solder joint connecting two substrates, which comprises:
a lead-free solder layer attached to a surface of a first substrate, said lead-free solder contains tin and is substantially free of lead;
an indium-containing layer attached to a surface of a second substrate, said indium-containing layer is indium or an indium alloy having a melting point lower than a melting point of said lead-free solder; and
a gradient layer connecting said lead-free solder layer to said indium-containing layer, said gradient layer having a substantially increasing gradient of indium content from said lead-free solder layer towards said indium-containing layer, and said gradient layer comprising a liquid phase reaction product of said lead-free solder layer and said indium-containing layer.

2. The solder joint as claimed in claim 1, wherein said lead-free solder is tin.

3. The solder joint as claimed in claim 1, wherein said lead-free solder is a tin alloy.

4. The solder joint as claimed in claim 3, wherein said tin alloy is a Sn—Ag, Sn—Cu, or Sn—Ag—Cu alloy.

5. The solder joint as claimed in claim 1, wherein said indium-containing layer is indium.

6. The solder joint as claimed in claim 2, wherein said indium-containing layer is indium, and said liquid phase reaction product comprises a eutectic Sn—In alloy.

7. The solder joint as claimed in claim 3, wherein said indium-containing layer is indium, and said liquid phase reaction product comprises a eutectic Sn—In alloy.

8. The solder joint as claimed in claim 4, wherein said indium-containing layer is indium, and said liquid phase reaction product comprises a eutectic Sn—In alloy.

9. The solder joint as claimed in claim 1, wherein said solder joint contains less than 49 wt % of indium, based on the total weight of said solder joint.

10. The solder joint as claimed in claim 9, wherein said solder joint contains less than 30 wt % of indium, based on the total weight of said solder joint.

11. A method for soldering two substrates, which comprises the following steps:
a) preparing a first substrate having an indium-containing lead-free solder bump comprising a lead-free solder layer attached to a surface of said first substrate, and an indium-containing layer formed on said lead-free solder layer, wherein said lead-free solder comprises tin and is substantially free of lead, and said indium-containing layer is indium or an indium alloy having a melting point lower than a melting point of said lead-free solder;
b) contacting said surface of said first substrate with a surface of a second substrate, and heating said indium-containing lead-free solder bump to melt said indium-containing layer and initiate a liquid phase reaction of said indium-containing layer and said lead-free solder layer; and
c) cooling said indium-containing lead-free solder bump between the two surfaces of said first substrate and said second substrate to bind said first substrate and said second substrate.

12. The method as claimed in claim 11, wherein said indium-containing lead-free solder bump is formed by electroplating, depositing or printing a lead-free solder layer on the surface of said first substrate, and electroplating, depositing or printing an indium-containing layer on said lead-free solder layer.

13. The method as claimed in claim 12, wherein said indium-containing layer is electroplated on said lead-free solder layer.

14. The method as claimed in claim 11, wherein said lead-free solder is tin.

15. The method as claimed in claim 11, wherein said lead-free solder is a tin alloy.

16. The method as claimed in claim 15, wherein said tin alloy is Sn—Ag, Sn—Cu, or Sn—Ag—Cu.

17. The method as claimed in claim 11, wherein said indium-containing layer is indium, and said liquid phase reaction forms a eutectic Sn—In alloy.

18. The method as claimed in claim 12, wherein said indium-containing layer is indium, and said liquid phase reaction forms a eutectic Sn—In alloy.

19. The method as claimed in claim 13, wherein said indium-containing layer is indium, and said liquid phase reaction forms a eutectic Sn—In alloy.

20. The method as claimed in claim 14, wherein said indium-containing layer is indium, and said liquid phase reaction forms a eutectic Sn—In alloy.

21. The method as claimed in claim 15, wherein said indium-containing layer is indium, and said liquid phase reaction forms a eutectic Sn—In alloy.

22. The method as claimed in claim 16, wherein said indium-containing layer is indium, and said liquid phase reaction forms a eutectic Sn—In alloy.

23. The method as claimed in claim 11, wherein said indium-containing lead-free solder bump contains less than 49 wt % of indium, based on the total weight of said indium-containing lead-free solder bump.

24. The method as claimed in claim 23, wherein said indium-containing lead-free solder bump contains less than 30 wt % of indium, based on the total weight of said indium-containing lead-free solder bump.
